(19) United States
(12) Patent Application Publication
(10) Pub. No.: US 2024/0053176 A1
(43) Pub. Date: Feb. 15, 2024

(54) CALIBRATION TESTING TEMPLATE

(71) Applicant: Nuvolo Technologies Corporation, Paramus, NJ (US)

(72) Inventors: Tejas Yadav, Cheshire, CT (US); James Wilton, Cottonwood, AZ (US); Abhishek Kulkarni, Pune (IN); Neeru Singla, Pune (IN)

(21) Appl. No.: 18/331,132

(22) Filed: Jun. 7, 2023

Related U.S. Application Data
(60) Provisional application No. 63/397,519, filed on Aug. 12, 2022.

(51) Int. Cl. G01D 18/00; G06F 11/263

(52) U.S. Cl. CPC G01D 18/00; G06F 11/263

(57) ABSTRACT

Methods, systems, and storage media for providing a calibration testing template are disclosed. Exemplary implementations may: provide, at a user interface and using at least one processor associated with a calibration testing template, a customized testing data sheet comprising a plurality of test points; receive, from the test data input cell and using the at least one processor, a test data input associated with an equipment item; receive, from the test data output cell and using the at least one processor, a test data output associated with the equipment item; determine, using the at least one processor and based on the received test data input and test data output, an output error; and determine, using the at least one processor and based on the determined output error, a status result of the equipment item.

### CROSS-REFERENCE TO RELATED APPLICATIONS

This application claims the benefit of U.S. Provisional Application Ser. No. 63/397,519, filed Aug. 12, 2022, entitled “Calibration Testing Template,” the contents of which are incorporated by reference herewith in its entirety.

### TECHNICAL FIELD

This disclosure relates to methods and systems for calibration, and more specifically to methods and systems for providing a calibration testing template.

### BACKGROUND

Generally speaking, calibration may be performed to ensure accurate measurements. Calibration, put simply, may include a comparison of measurement values of a device under test with those of a reference standard (i.e., a “calibrator”) of a known accuracy. A reference standard may include a measurement device of a known accuracy. Examples of reference standards may include one or more of a device generating a physical quantity such as a voltage, temperature, or pressure; a physical artefact such as a meter ruler or a weight; and/or other reference standards. Calibration may include an act of comparison but may not include any adjustment, such as no adjustment to the device under test. Outcomes of a calibration may include one or more of no significant error being noted on the device under test, a significant error being noted but no adjustment made, a significant error being noted and an adjustment made to correct the error to an acceptable level, and/or other outcomes.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

One aspect of the present disclosure relates to a method for providing a calibration testing template. The method may include providing, at a user interface and using at least one processor associated with a calibration testing template, a customized testing data sheet including a plurality of test points. Each test point of the plurality of test points may include a target input indicator, a test data input cell, and a test data output cell. The method may include receiving, from the test data input cell and using the at least one processor, a test data input associated with an equipment item. The method may include receiving, from the test data output cell and using the at least one processor, a test data output associated with the equipment item. The method may include determining, using the at least one processor and based on the received test data input and test data output, an output error. The method may include determining, using the at least one processor and based on the determined output error, a status result of the equipment item.

Another aspect of the present disclosure relates to a system configured for providing a calibration testing template. The system may include one or more hardware processors configured by machine-readable instructions. The processor(s) may be configured to provide, at a user interface and using at least one processor associated with a calibration testing template, a customized testing data sheet including a plurality of test points. Each test point of the plurality of test points may include a target input indicator, a test data input cell, and a test data output cell. The processor(s) may be configured to receive, from the test data input cell and using the at least one processor, a test data input associated with an equipment item. The processor(s) may be configured to receive, from the test data output cell and using the at least one processor, a test data output associated with the equipment item. The processor(s) may be configured to determine, using the at least one processor and based on the received test data input and test data output, an output error. The processor(s) may be configured to determine, using the at least one processor and based on the determined output error, a status result of the equipment item.

Yet another aspect of the present disclosure relates to a non-transient computer-readable storage medium having instructions embodied thereon, the instructions being executable by one or more processors to perform a method for providing a calibration testing template. The method may include providing, at a user interface and using at least one processor associated with a calibration testing template, a customized testing data sheet including a plurality of test points. Each test point of the plurality of test points may include a target input indicator, a test data input cell, and a test data output cell. The method may include receiving, from the test data input cell and using the at least one processor, a test data input associated with an equipment item. The method may include receiving, from the test data output cell and using the at least one processor, a test data output associated with the equipment item. The method may include determining, using the at least one processor and based on the received test data input and test data output, an output error. The method may include determining, using the at least one processor and based on the determined output error, a status result of the equipment item.

### BRIEF DESCRIPTION OF THE DRAWINGS

FIG. 1 illustrates an example computing system including a calibration testing template, according to some embodiments of the present disclosure.

FIGS. 2A, 2B, 2C, 2D, 2E, 2F, 2G, and 2H illustrate example views of a customized testing data sheet interface of the calibration testing template, according to some embodiments of the present disclosure.

FIGS. 3A, 3B, 3C, 3D, 3E, and 3F illustrate additional example views of a customized testing data sheet interface of the calibration testing template, according to some embodiments of the present disclosure.

FIG. 4 illustrates a system configured for processing a calibration testing template, according to some embodiments of the present disclosure.

FIG. 5 illustrates an example process associated with a calibration testing template, according to some embodiments of the present disclosure.

FIG. 6 is a diagram of an example computer system configured for processing a calibration testing template, according to some embodiments of the present disclosure.

Like reference numbers and designations in the various drawings indicate like elements.

### DETAILED DESCRIPTION

A calibration testing template can be customized for calibration testing of an equipment item by a user. For example, the calibration testing template can include a customized testing data sheet that includes a plurality of test points for assisting with calibration testing of the equipment item. The test points can define one or more target inputs for inputting/applying to the equipment item. For example, the user can input/apply the target inputs to the equipment item for measuring/observing a test data output. The test points of the customized testing data sheet can include cells for allowing the user to input an actual value that was input/provided to the equipment item and a measured/observed value output by the equipment item. The calibration testing template can determine an output error based on the actual input value and output entered into the cells of the customized testing data sheet. The calibration testing template can determine whether the equipment item passes or fails calibration testing based on the outcome of the test points. In the present disclosure, the terms “cell” and “field” may be used interchangeably.

Some advantages of the calibration testing data template include enabling users (e.g., technicians) to efficiently and correctly submit, update, and analyze test data associated with the calibration testing of the equipment item. Further, the data sheet user interface can allow a user to efficiently select reference standards to be assigned to test data input and output. Additionally, at least the output errors can be displayed graphically and/or a summary of the testing data can be displayed on a user interface to allow a user to efficiently understand and identify any issues with the calibration testing of the equipment item. For example, the summary can be provided to the user for allowing the user to review testing results before formal submissions.

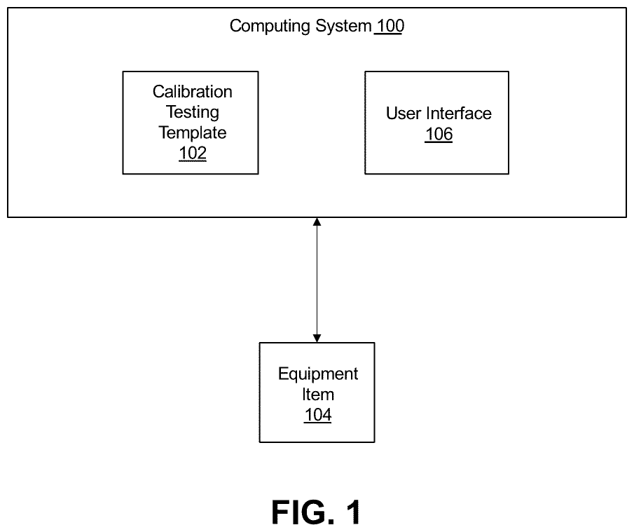

FIG. 1 illustrates an example computing system 100 including a calibration testing template 102, according to some embodiments of the present disclosure. The computing system 100 may be in communication with at least one equipment item 104 (e.g., a device, instrument, and/or other calibratable equipment item). In some embodiments, the system 100 may include a user interface 106 and/or other components.

Accurate calibrations measurements may be foundational to quality and safety of products and services that people rely on and use daily. As such, in many business and other organizations, calibrations are performed regularly. Conventional approaches, however, may be inefficient and prone to human error and/or unpredictable differences between subsequent calibrations of a given device, rendering the calibration measurements unreliable.

Implementations described herein address the aforementioned shortcomings and other shortcomings by providing customizable calibration testing templates and/or customizable testing data sheets. For example, in some implementations, an admin user may customize calibration testing templates used by technician users to facilitate calibration procedures yielding populated testing data sheets. Exemplary implementations may provide reliable calibration measurements to facilitate quality compliance with a company's own quality management system (QMS), safety compliance with local safety and/or environment laws, regulatory compliance with regulations that govern the industry or industries in which a company operates (e.g., US FDA), and/or adherence to other business requirements.

The computing system 100 may be configured to perform and/or facilitate calibration processes. Calibration may be desirable and/or required for various reasons. Examples of such reasons may include one or more of when commissioning a new equipment item, after equipment item 104 has been repaired and/or modified, when a specified time period has elapsed, when a specified usage (e.g., operating hours) has elapsed, before and/or after a critical measurement, before and/or after a critical manufacturing and/or testing process, after an event (e.g., after an instrument has been exposed to a shock, vibration, and/or physical damage, sudden changes in weather, and/or other events), when observations appear questionable and/or instrument indications do not match an output of surrogate instruments, as specified by a requirement (e.g., customer specification, instrument manufacturer recommendation, and/or other requirements), and/or other reasons.

According to some embodiments, calibration may include a process of adjusting an output and/or indication on equipment item 104 to agree with a value of an applied standard within a specified uncertainty. In some embodiments, a calibration process may begin with a design of equipment item 104 that needs to be calibrated. The design may be able to stay in calibration throughout its calibration interval. In other words, the design may be capable of measurements that are within a process tolerance when used within its environmental specifications for a pre-defined period of time. Having a design with these characteristics may increase a likelihood of the equipment item performing as expected. Calibration may help maintain a quality of measurement and/or help ensure correct functioning of equipment item 104.

Various types of users may be involved with calibrations. For example, calibrations may involve one or more of a calibration administrator, a calibration engineer, a quality engineer, a calibration technician, and/or other types of users. A calibration administrator or “metrologist” may include a senior manager responsible for a company's measurement and calibration policies. A company might only have a single calibration administrator for many sites or a calibration administrator per site. According to some embodiments, a calibration administrator may be enabled to create, edit, and/or delete records under calibration management. A calibration engineer may include a site level manager or, if there is more than one laboratory/workshop per site, a manager of a single laboratory/workshop. In some embodiments, a calibration engineer may view and/or edit records under calibration management (e.g., for their laboratory/workshop). A quality engineer may include a company level user, site level user, or department level user. In some embodiments, a quality user may have read only access to records under calibration management. A calibration technician may include a site level technician or, if there is more than one laboratory/workshop per site, they may work from a single laboratory/workshop. A calibration technician may work on actual calibration work assigned to him/her. A calibration technician may enter observations on work order and/or make related notes (e.g., via user interface 106).

In some embodiments, calibration processes may involve a reference standard or “calibrator.” For example, when equipment item 104 is calibrated, measurement traceability may provide confidence in the validity of the results of the calibration and in turn the validity of measurements of the equipment item itself. To achieve measurement traceability, some embodiments may provide a database of all physical reference standards that a calibration technician has access to. The calibration technician may select (e.g., via user interface 106) one or more specific reference standards being used and/or link it/them to a calibration record to give traceability. To facilitate management of reference standards, the database may store one or more of physical details, status, measurement capabilities, associated uncertainties, calibration details, and/or other information associated with individual reference standards. This may help ensure that use and maintenance of reference standards is appropriately controlled.

According to some embodiments, tolerance units may define an error calculation method. Examples of such methods may include one or more of % SPAN, % READING, EU, and/or other methods. For % SPAN, an error calculation may be expressed as a percent of a span based on an equipment item (e.g., equipment item 104) under test or device under test (DUT) measurement span. For example, if a DUT span is +/−200 mbar, 1 percent of span would be +/−2 mbar. For % READING, an error calculation may be expressed as a percent of a reading based on the DUT reading. For example, if the DUT reading is 100 mbar, 1 percent of reading would be +/−1 mbar and, if the DUT reading is 200 mbar, 1 percent of reading would be +/−2 mbar. For EU, the error calculation may be expressed in engineering units (EU) based on an output of the DUT. For example, if an output is in mbar, the EU error would be in mbar.

Some embodiments may provide measurement types lists of some or all commonly used units of measure (e.g., 90+) for calibration. The measurement types may be categorized based on physical quantities. Examples of physical quantities may include one or more of electrical, pressure, dimension, time, mass, temperature, and/or other physical quantities. The physical quantities may be used to help ensure only valid input and output unit of measure combinations are used. In some embodiments, if a unit of measure is not listed, it can be added with an appropriate physical quantity selected (e.g., via user interface 106) or a custom unit of measure may be added to a calibration testing template (e.g., calibration testing template 102).

Some implementations may provide and/or facilitate one or more transfer functions including one or more of a standard linear transfer function, a square transfer function, a square root transfer function, and/or other transfer functions. A transfer function may define a relationship between an input and output. A transfer function may be used to calculate a target output based and an actual input value. An actual output value may be evaluated against the target output value for error calculation. In some embodiments, input/output quantities may include physical quantities to help ensure only valid input and output unit of measure combinations are used.

The calibration testing template 102 may be configured to define calibration data sheet configurations. For example, calibration data sheet input and output details, tolerance ranges, and/or other information may be defined via the calibration testing template 102. In some embodiments, the calibration testing template 102 may be populated based on calibration-related work order. According to some embodiments, a calibration technician may add and/or modify calibration data sheets on respective assigned work orders, but only a calibration administrator may create and/or modify the calibration testing template 102.

The calibration testing template 102 may define a calibration process for one or more functions of equipment item 104. The calibration testing template 102 may be used to create calibration data sheets for calibrated equipment items. Calibration data sheets may be associated with individual equipment items. Calibration data sheets may be copied to calibration work orders for a given equipment item. Calibration data sheets may provide calibration technicians with information needed to perform a calibration. A calibration data sheet may define a functional specification of equipment item 104. Examples of such functional specifications may include one or more of input and output physical (measurement) quantities and units input and output measurement ranges, pass/fail status, adjust tolerances, one or more calibration points of equipment item 104, and/or other functional specifications. In some implementations, a calibration data sheet may define one or more inspection parameters (e.g., a checklist) of equipment item 104. In some embodiments, a calibration technician may enter (e.g., via user interface 106) calibration results on a calibration data sheet. On completion of the calibration process, results may be saved to and/or otherwise associated with a work order (e.g., at an equipment item level). Over a number of calibration cycles, a drift history (e.g., trend data) of equipment item 104 may be established or provided. The drift history may be used to predict when equipment item 104 might drift out of calibration. Depending on the drift history of equipment item 104, a calibration frequency may be reduced (e.g., to help ensure asset measurement quality is kept at an acceptable level) or increased (e.g., reducing a number of calibrations needed and associated costs).

According to some embodiments, a process flow of a calibration data sheet may include one or more of calibration testing template definition, calibration testing template configuration, calibration data sheet population, calibration data sheet execution, and/or other steps. During calibration testing template definition, a calibration administration may define calibration testing templates with different types of attributes such as one or more of calibration method, test type, application type, measurement type, measurement services, input/output range details, input/output tolerance details, data sheet item definitions, instrument types, and/or other attributes. Calibration testing template configuration may utilize data packages based on a condition of equipment item 104, work order type, work package definition, and/or other information. Calibration data sheets (e.g., in terms of work order task) may be generated on work orders for respective equipment items (e.g., equipment item 104). Calibration administrators may configure calibration testing template 102 based on work package definitions. In some implementations, multiple calibration testing templates (e.g., calibration testing template 102) may be contemporaneously attached to or associated with a single work package definition. During calibration data sheet population and/or execution, if a work order type and an equipment item name of a newly created work order are matched with a work package definition, then one or more work order tasks and/or work order task procedures may be created on a work order. The work order tasks and/or work order task procedures may be used as calibration data sheets to enter calibration reading data (e.g., via user interface 106). A number of work order tasks may be equal to a number on calibration testing templates defined on a work package definition. A number of work order task procedures may be equal to a number of data sheet item definitions defined on calibration testing templates (e.g., calibration testing template 102), which may be used to note down individual test readings. Calibration work orders may be assigned to calibration technicians who work on calibration work order tasks and work order task procedures.

Some embodiments may facilitate or otherwise support one or more calibration test types. Examples of such calibration test type may include one or more of a repeatability test, an eccentricity test (or shift test), and/or other calibration test types. A repeatability test may be associated with a repeatability condition of measurement out of a set of conditions that includes the same measurement procedure, same operators, same measuring system, same operating conditions and same location, and replicate measurements on the same or similar objects over a short period of time. A condition of measurement may be a repeatability condition only with respect to a specified set of repeatability conditions. In some embodiments, a repeatability test may be performed by only one calibration technician at a time, at the same location, and with same equipment item. The same input may be repeated for a given number of times (e.g., checking of temperature ten times). An eccentricity test may be associated with a procedure done by a calibration technician to check an accuracy of weighing equipment. During this test, the calibration technician may center weights in different quadrants on a weighing platform while checking the readings. Eccentricity tests may help ensure that no matter the placement of a weight on a weighing platform, the reading remains the same or within a tolerance of the equipment item. In some embodiments, an eccentricity test may be conducted with a half-capacity test load centered successively at four points positioned equidistance between the center and the front, left, back, and right edges of a weighing platform.

In some embodiments, the calibration testing template 102 may be displayed via user interface 106. In some instances, the user interface 106 may be configured to receive user input. For example, the user interface 106 may be configured to allow a user to enter information related to the calibration testing template 102, a calibration data sheet, and/or other information related to calibration. The user interface 106 may be configured to allow a user to modify information that already exists in some or all fields or cells of the calibration testing template 102. In some implementations, the user interface 106 may allow a user to enter or modify information in a field or cell, while disabling the modification of some or all other information in the calibration testing template 102. In some instances, the user interface 106 may be configured to display the calibration testing template 102 for viewing purposes without allowing a user to modify information contained therein or input any additional information into the calibration testing template 102.

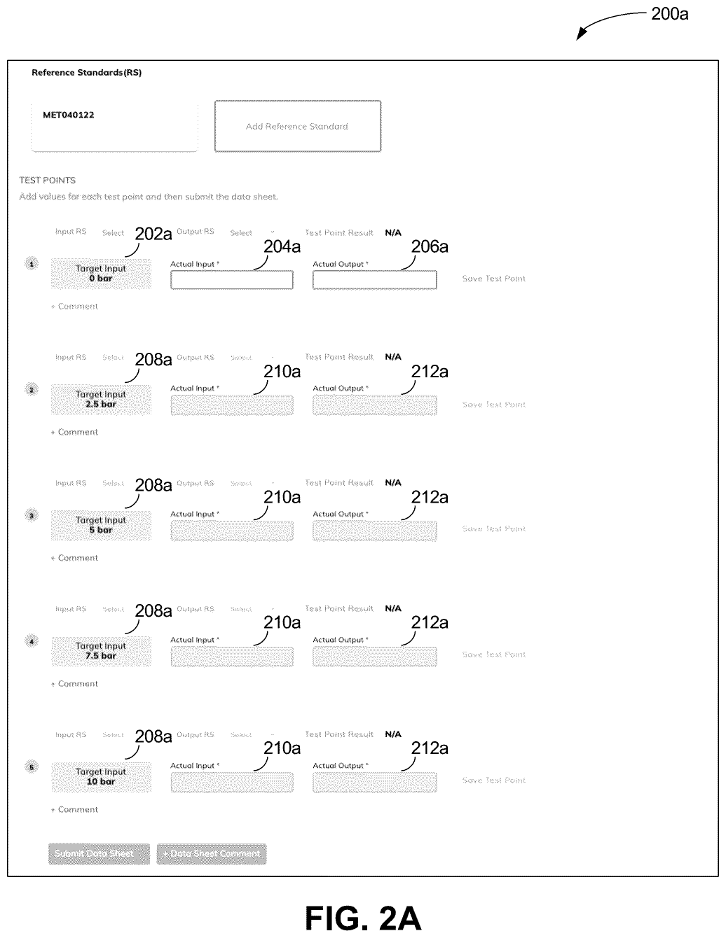

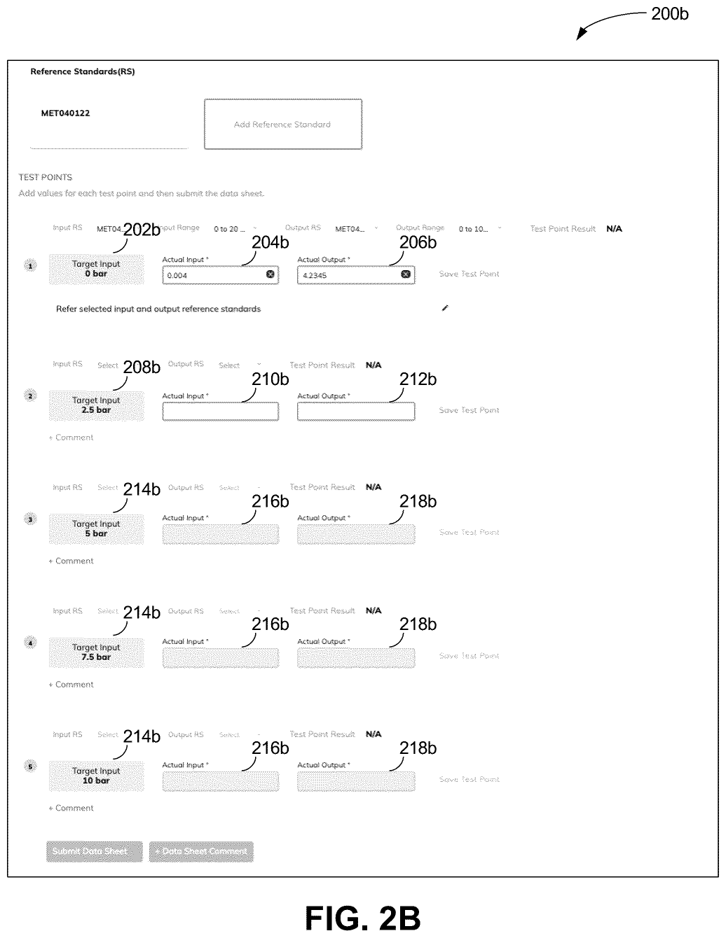

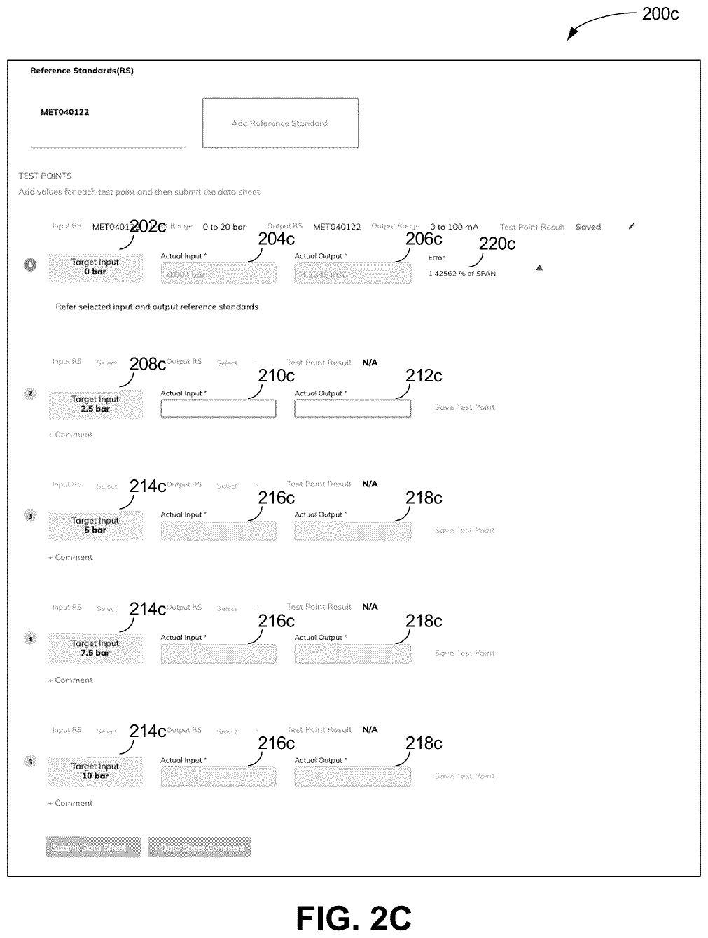

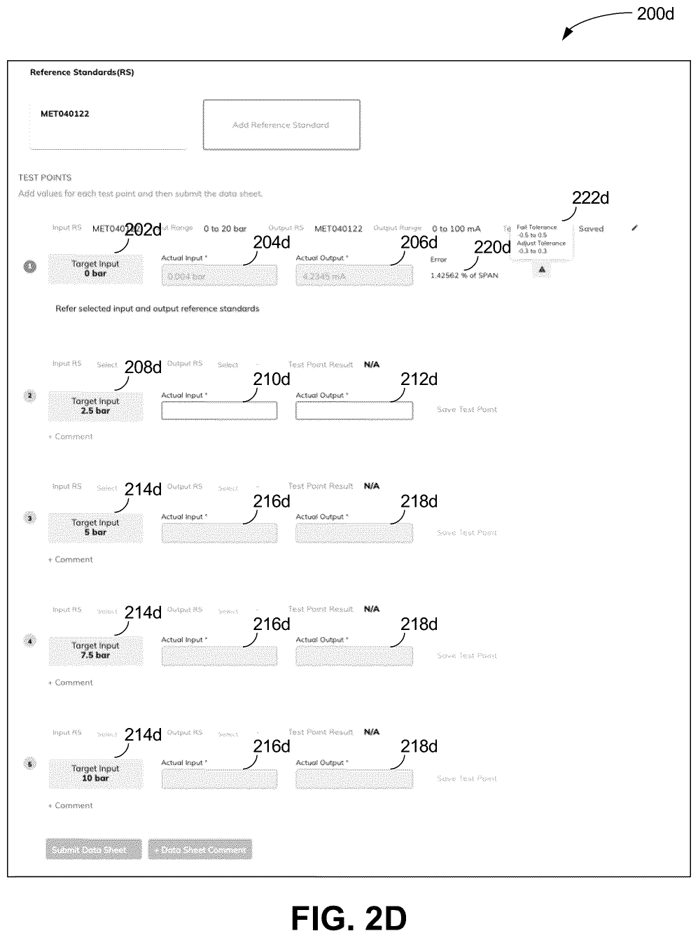

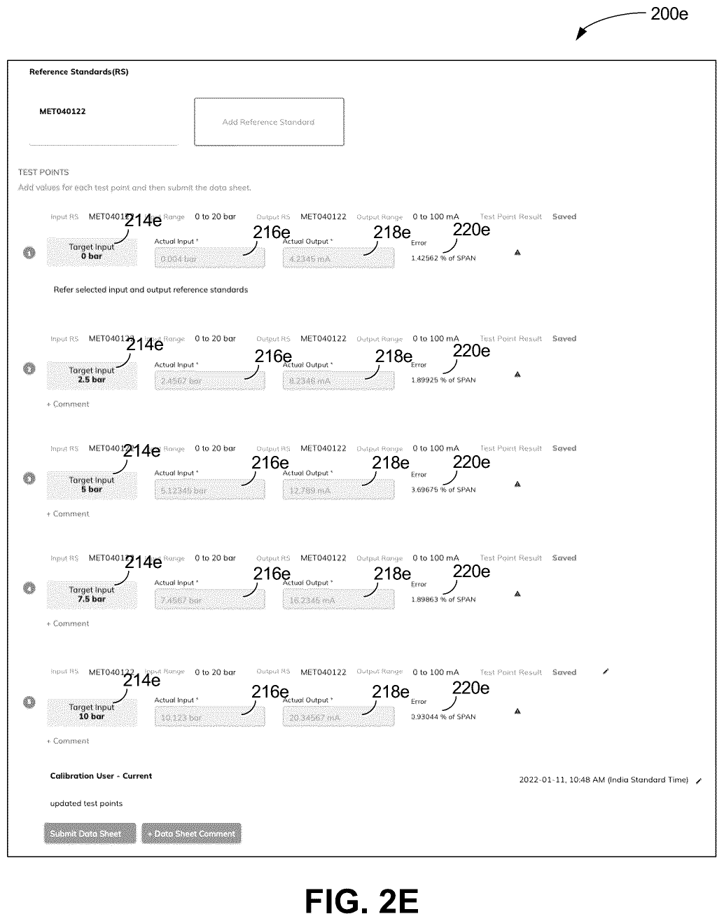

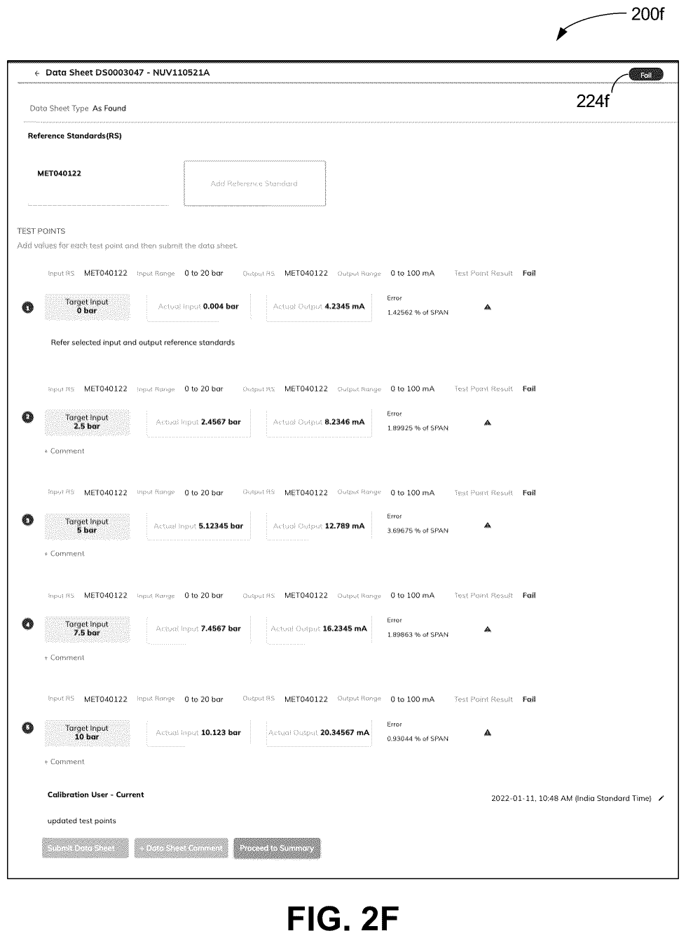

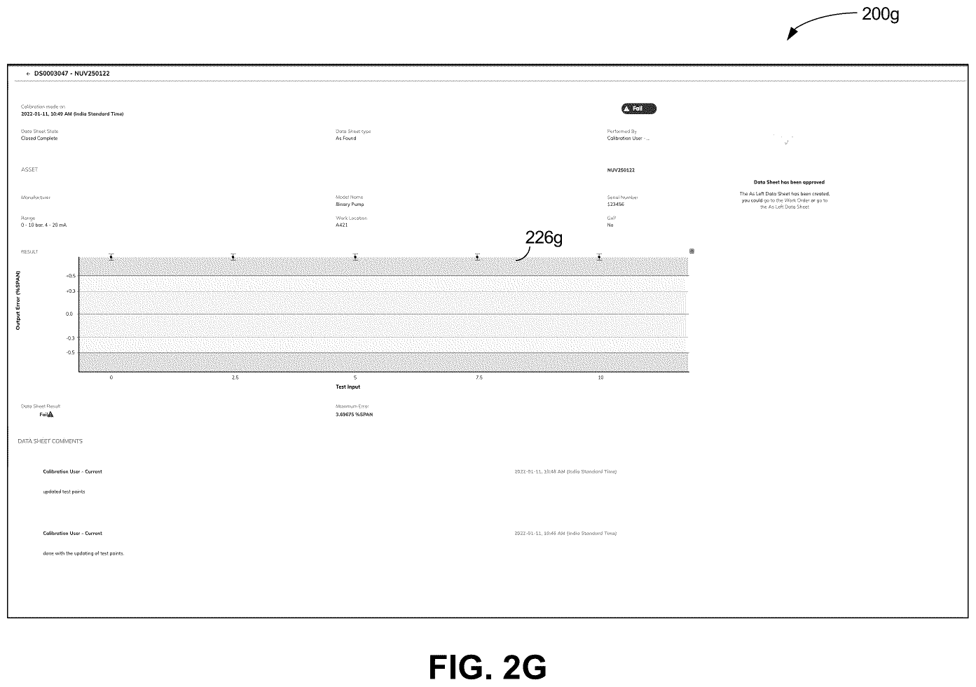

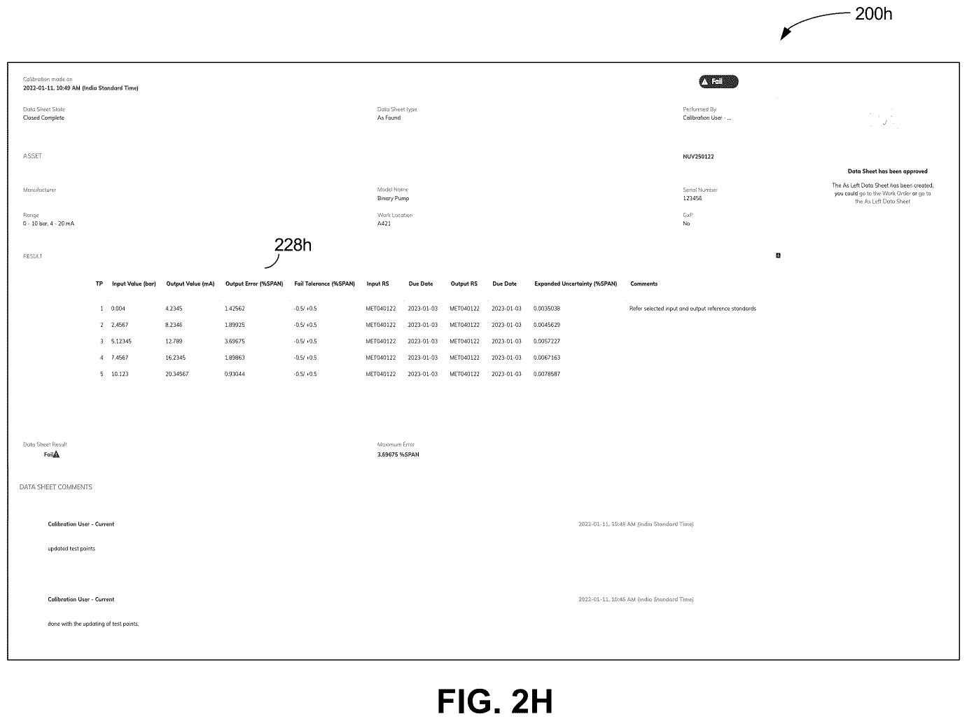

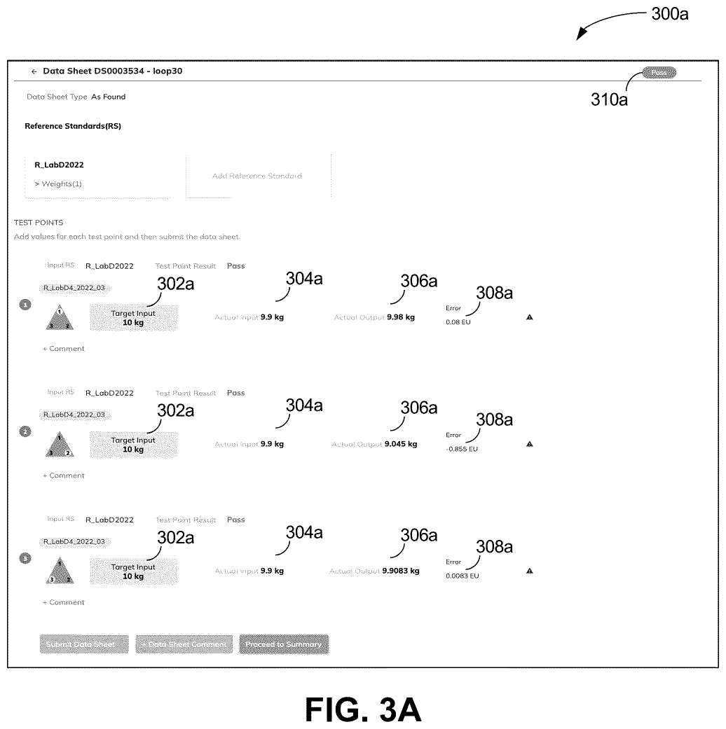

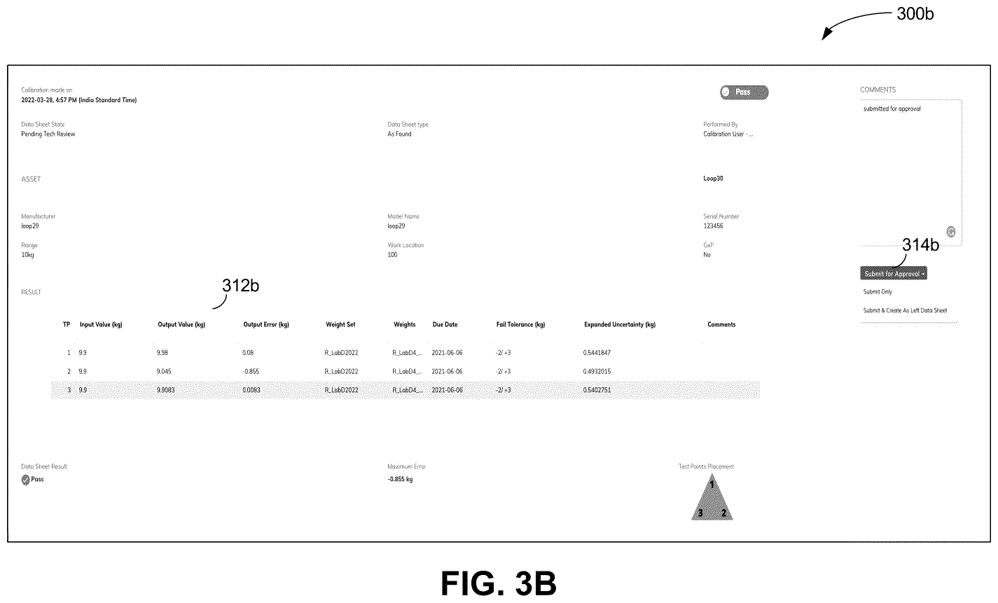

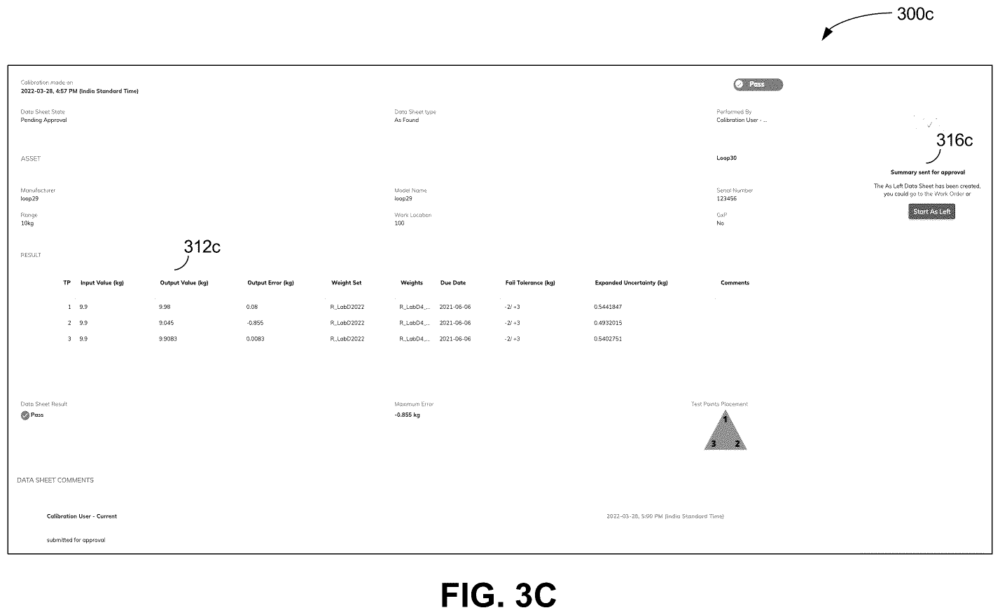

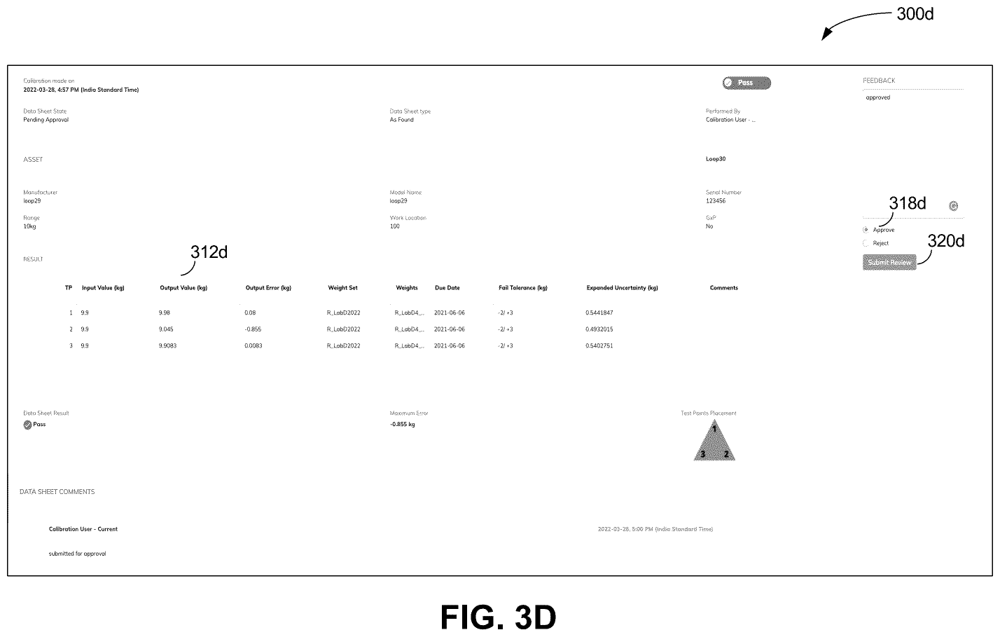

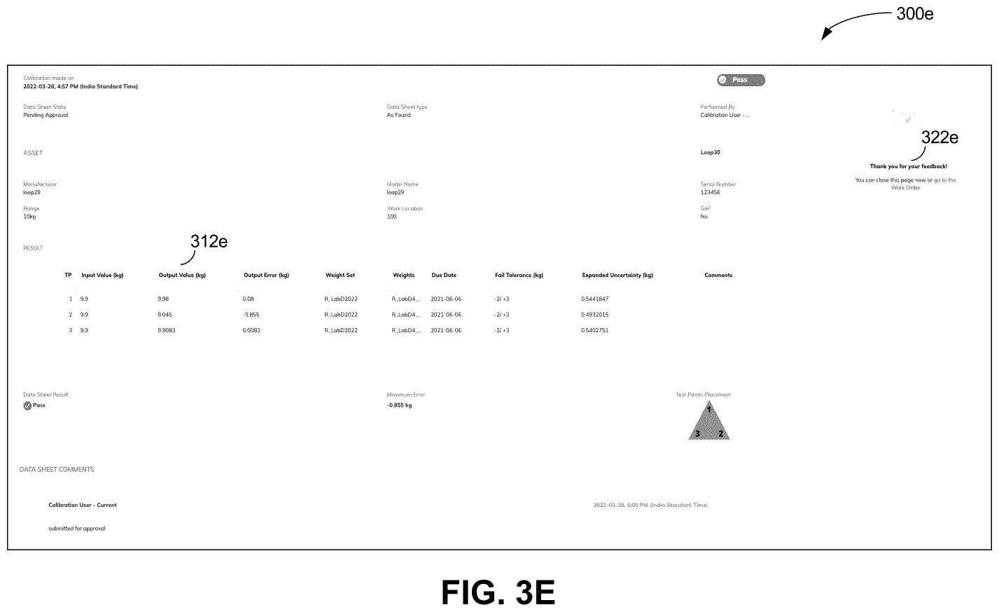

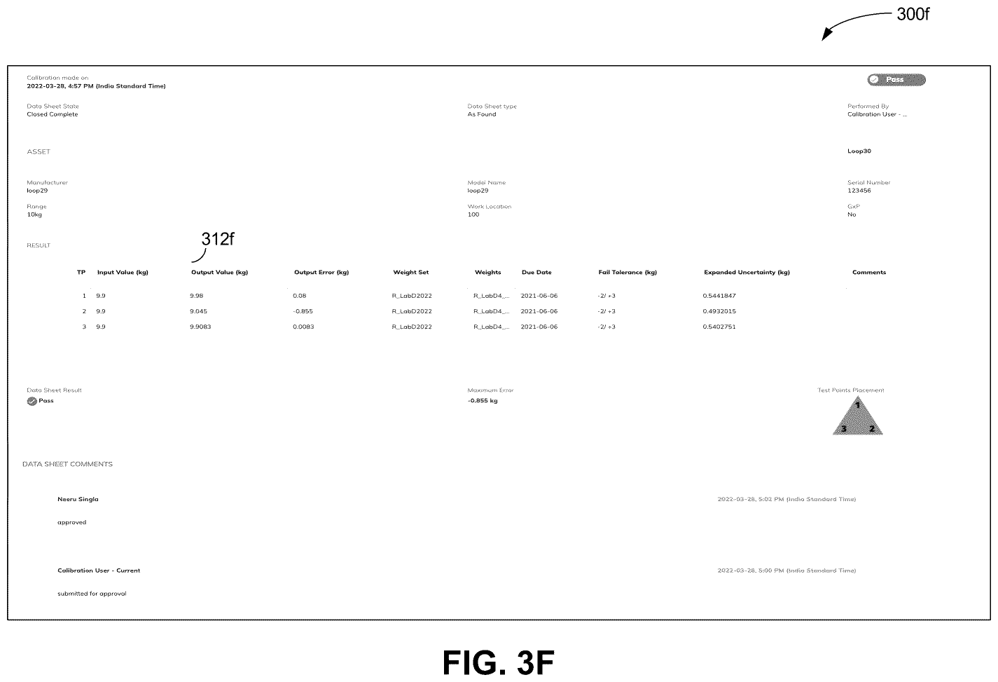

FIGS. 2A, 2B, 2C, 2D, 2E, 2F, 2G, and 2H illustrate example views of a customized testing data sheet interface of the calibration testing template 102, according to some embodiments of the present disclosure. The device under testing may include a pressure measuring device or equipment item (e.g., equipment item 104). FIGS. 3A, 3B, 3C, 3D, 3E, and 3F illustrate additional example views of a customized testing data sheet interface of the calibration testing template 102, according to some embodiments of the present disclosure. The device under testing may include a weight measuring device or equipment item (e.g., equipment item 104). The views of a customized testing data sheet interface may by displayed via user interface 106.

FIG. 2A illustrates example view 200a associated with calibration testing template 102, according to some embodiments of the present disclosure. The view 200a includes target input field 202a, actual input field 204a, actual output field 206a, and/or other components. In view 200a, the target input field 202a is populated with the value “0 bar,” while the actual input field 204a and the actual output field 206a are each unpopulated but editable by a user. The view 200a further includes target input fields 208a, actual input fields 210a, actual output fields 212a, and/or other components. In view 200a, the target input fields 208a are populated with various values, while the actual input fields 210a and the actual output fields 212a are each unpopulated and cannot be edited by the user.

FIG. 2B illustrates example view 200b associated with calibration testing template 102, according to some embodiments of the present disclosure. The view 200b includes target input field 202b, actual input field 204b, actual output field 206b, and/or other components. In view 200b, the target input field 202b is populated with the value “0 bar,” the actual input field 204b is populated with the value “0.004,” and the actual output field 206b is populated with the value “4.2324.” The actual input field 204b and the actual output field 206b may be modified by the user. In view 200b, the target input field 208b is populated with the value “2.5 bar,” while the actual input field 210b and the actual output field 212b are each unpopulated but editable by a user. The view 200b further includes target input fields 214b, actual input fields 216b, actual output fields 218b, and/or other components. In view 200b, the target input fields 214b are populated with various values, while the actual input fields 214b and the actual output fields 218b are each unpopulated and cannot be edited by the user.

FIG. 2C illustrates example view 200c associated with calibration testing template 102, according to some embodiments of the present disclosure. The view 200c includes target input field 202c, actual input field 204c, actual output field 206c, and/or other components. In view 200c, the target input field 202c is populated with the value “0 bar,” the actual input field 204c is populated with the value “0.004,” and the actual output field 206c is populated with the value “4.2324.” The actual input field 204c and the actual output field 206c cannot be modified by the user. An error 220c associated with the actual input field 204c and the actual output field 206c is shown with a value of “1.42562% of SPAN.” In view 200c, the target input field 208c is populated with the value “2.5 bar,” while the actual input field 210c and the actual output field 212c are each unpopulated but editable by a user. The view 200c further includes target input fields 214c, actual input fields 216c, actual output fields 218c, and/or other components. In view 200c, the target input fields 214c are populated with various values, while the actual input fields 214c and the actual output fields 218c are each unpopulated and cannot be edited by the user.

FIG. 2D illustrates example view 200d associated with calibration testing template 102, according to some embodiments of the present disclosure. The view 200d includes target input field 202d, actual input field 204d, actual output field 206d, and/or other components. In view 200d, the target input field 202d is populated with the value “0 bar,” the actual input field 204d is populated with the value “0.004,” and the actual output field 206d is populated with the value “4.2324.” The actual input field 204d and the actual output field 206d cannot be modified by the user. An error 220d associated with the actual input field 204d and the actual output field 206d is shown with a value of “1.42562% of SPAN.” A prompt 222d provides a message indicating “Fail Tolerance −0.5 to 0.5” and “Adjust Tolerance −0.3 to 0.3.” In view 200d, the target input field 108d is populated with the value “2.5 bar,” while the actual input field 210d and the actual output field 212d are each unpopulated but editable by a user. The view 200d further includes target input fields 214d, actual input fields 216d, actual output fields 218d, and/or other components. In view 200d, the target input fields 214d are populated with various values, while the actual input fields 214d and the actual output fields 218d are each unpopulated and cannot be edited by the user.

FIG. 2E illustrates example view 200e associated with calibration testing template 102, according to some embodiments of the present disclosure. The view 200e includes target input fields 214e, actual input fields 216e, actual output fields 218e, and/or other components. In view 200e, the target input fields 214e, the actual input fields 214d, and the actual output fields 218e are each populated with various values and cannot be edited by the user. For each set of individual actual input fields 214e and actual output fields 218e, the view 200e includes a different error 220e with various values.

FIG. 2F illustrates example view 200f associated with calibration testing template 102, according to some embodiments of the present disclosure. The view 200f is similar to the view 200e in FIG. 2E, but further includes a fail indication 224e conveying that the equipment item 104 did not pass a calibration test.

FIG. 2G illustrates example view 200g associated with calibration testing template 102, according to some embodiments of the present disclosure. The view 200g includes a graphical representation 226g of completed test points. The graphical representation 226g may include a graph and/or other visual representation of completed test points. The graphical representation 226g of completed test points may include one or more of a tested input, a determined output error, and/or other information.

FIG. 2H illustrates example view 200h associated with calibration testing template 102, according to some embodiments of the present disclosure. The view 200h includes a summary 228h of completed test points. The summary 228h may include a table, list, and/or other textual summarization of completed test points. By way of non-limiting example, the summary 228h of completed test points may include one or more of a tested input, a tested output, a determined output error, and/or other information.

FIG. 3A illustrates example view 300a associated with calibration testing template 102, according to some embodiments of the present disclosure. The view 300a includes target input fields 302a, actual input fields 304a, actual output fields 306a, and/or other components. In view 300a, the target input fields 302a, the actual input fields 304a, and the actual output fields 306a are each populated with various values (e.g., weight values in kilograms). For each set of individual actual input fields 304a and actual output fields 306a, the view 300a includes a different error 308a with various values (e.g., “0.08 EU,”−0.855 EU,” and “0.0083 EU”). In addition, the view 300a includes a pass indication 310a conveying that the equipment item 104 did pass a calibration test.

FIG. 3B illustrates example view 300b associated with calibration testing template 102, according to some embodiments of the present disclosure. The view 300b includes a summary 312b of completed test points. The summary 312b may include a table, list, and/or other textual summarization of completed test points. The view 300b includes a prompt 314b for user selection (e.g., “Submit for Approval,” “Submit Only,” or “Submit & Create As Left Data Sheet”).

FIG. 3C illustrates example view 300c associated with calibration testing template 102, according to some embodiments of the present disclosure. The view 300c includes a summary 312c of completed test points. The summary 312c may include a table, list, and/or other textual summarization of completed test points. The view 300c includes a notification 316c that the summary 312c has been sent for approval.

FIG. 3D illustrates example view 300d associated with calibration testing template 102, according to some embodiments of the present disclosure. The view 300d includes a summary 312d of completed test points. The summary 312d may include a table, list, and/or other textual summarization of completed test points. The view 300d includes a user selectable input 318d to “Approve” or “Reject” the summary 312d and a button 320d to submit the review of the summary 312d.

FIG. 3E illustrates example view 300e associated with calibration testing template 102, according to some embodiments of the present disclosure. The view 300e includes a summary 312e of completed test points. The summary 312e may include a table, list, and/or other textual summarization of completed test points. The view 300e includes a confirmation 322e conveying that the review of the summary 312e has been successfully submitted (e.g., responsive to button 320d in FIG. 3D being clicked or tapped).

FIG. 3F illustrates example view 300f associated with calibration testing template 102, according to some embodiments of the present disclosure. The view 300f includes a summary 312f of completed test points. The summary 312f may include a table, list, and/or other textual summarization of completed test points. The view 300f shows a completed data sheet.

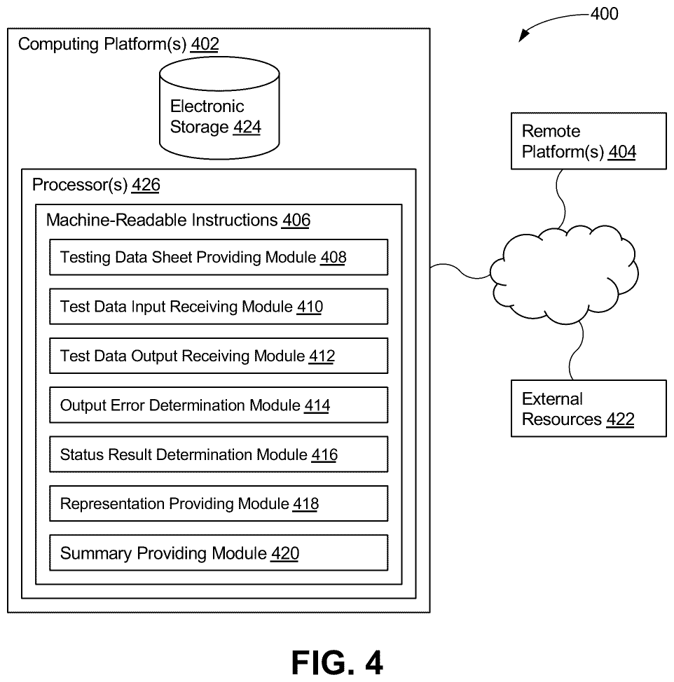

FIG. 4 illustrates a system 400 configured for processing a calibration testing template, in accordance with one or more embodiments. In some embodiments, system 400 may include one or more computing platforms 402. Computing platform(s) 402 may be configured to communicate with one or more remote platforms 404 according to a client/server architecture, a peer-to-peer architecture, and/or other architectures. Remote platform(s) 404 may be configured to communicate with other remote platforms via computing platform(s) 402 and/or according to a client/server architecture, a peer-to-peer architecture, and/or other architectures. Users may access system 400 via remote platform(s) 404.

Computing platform(s) 402 may be configured by machine-readable instructions 406. Machine-readable instructions 406 may include one or more instruction modules. The instruction modules may include computer program modules. The instruction modules may include one or more of testing data sheet providing module 408, test data input receiving module 410, test data output receiving module 412, output error determination module 414, status result determination module 416, representation providing module 418, summary providing module 420, and/or other instruction modules.

Testing data sheet providing module 408 may be configured to provide, at a user interface and using at least one processor associated with a calibration testing template, a customized testing data sheet including a plurality of test points. By way of non-limiting example, the customized testing data sheet may be based on one or more of a type of the equipment item being calibration tested, a type of calibration testing to be completed, or a functional specification of the equipment item. The customized data sheet may include a user text entry cell associated with each of the plurality of test points. The test data input cells and the test data output cells of the plurality of test points may be positioned along a single user interface. By way of non-limiting example, a given one of the plurality of test points may include one or more of a target input, a tested input, a tested output, or an associated error. The user text entry cell may include a comment box configured for receiving user text that is saved along with data.

The test data input cells and the test data output cells of the plurality of test points being positioned along the single user interface may facilitate a minimum number of clicks required by a user to perform test points. By way of non-limiting example, each test point of the plurality of test points may include a target input indicator, a test data input cell, and a test data output cell. The target input indicator may include a value to be inputted or provided to the equipment item being calibration tested. A test data input cell may be configured to receive an actual value a user inputted or provided to the equipment item being calibration tested. The test data output cell may be configured to receive a measured or observed value output by the equipment item being calibration tested based on an actual value a user inputted or provided.

Test data input receiving module 410 may be configured to receive, from the test data input cell and using the at least one processor, a test data input associated with an equipment item. A test data input may include an actual value a user inputted or provided to the equipment item being calibration tested.

Test data output receiving module 412 may be configured to receive, from the test data output cell and using the at least one processor, a test data output associated with the equipment item. A test data output may include a measured or observed value output by the equipment item being calibration tested and based on an actual value a user inputted or provided to the equipment item. At least one reference standard may be assignable to the test data input and/or the test data output. A first reference standard may be assigned to the test data input and a second reference standard is assigned to the test data output. The at least one reference standard may include a measurement device of a known accuracy. The first reference standard may be different than the second reference standard and may include more than one applied reference standard. In some implementations, the first reference standard may be different than the second reference standard. In some implementations, the user interface may include a datasheet user interface.

Output error determination module 414 may be configured to determine, using the at least one processor and based on the received test data input and test data output, an output error. The output error may be determined based on a percent error of expected versus actual test data output. Determining whether the output error may be within a process tolerance includes using % SPAN.

Status result determination module 416 may be configured to determine, using the at least one processor and based on the determined output error, a status result of the equipment item. The status result of the equipment item may indicate whether the equipment item passes or fails calibration testing. Determining the status result of the equipment item may include determining whether the output error is within a process tolerance. The process tolerance may be adjustable by the user.

Representation providing module 418 may be configured to provide, at the user interface, a graphical representation of completed test points. The graphical representation of completed test points may include one or both of a tested input or a determined output error.

Summary providing module 420 may be configured to provide, at the user interface, a summary of completed test points. By way of non-limiting example, the summary of completed test points may include one or more of a tested input, a tested output, or a determined output error.

In some embodiments, computing platform(s) 402, remote platform(s) 404, and/or external resources 422 may be operatively linked via one or more electronic communication links. For example, such electronic communication links may be established, at least in part, via a network such as the Internet and/or other networks. It will be appreciated that this is not intended to be limiting, and that the scope of this disclosure includes embodiments in which computing platform(s) 402, remote platform(s) 404, and/or external resources 422 may be operatively linked via some other communication media.

A given remote platform 404 may include one or more processors configured to execute computer program modules. The computer program modules may be configured to enable an expert or user associated with the given remote platform 404 to interface with system 400 and/or external resources 422, and/or provide other functionality attributed herein to remote platform(s) 404. By way of non-limiting example, a given remote platform 404 and/or a given computing platform 402 may include one or more of a server, a desktop computer, a laptop computer, a handheld computer, a tablet computing platform, a NetBook, a Smartphone, a gaming console, and/or other computing platforms.

External resources 422 may include sources of information outside of system 400, external entities participating with system 400, and/or other resources. In some embodiments, some or all of the functionality attributed herein to external resources 422 may be provided by resources included in system 400.

Computing platform(s) 402 may include electronic storage 424, one or more processors 426, and/or other components. Computing platform(s) 402 may include communication lines, or ports to enable the exchange of information with a network and/or other computing platforms. Illustration of computing platform(s) 402 in FIG. 4 is not intended to be limiting. Computing platform(s) 402 may include a plurality of hardware, software, and/or firmware components operating together to provide the functionality attributed herein to computing platform(s) 402. For example, computing platform(s) 402 may be implemented by a cloud of computing platforms operating together as computing platform(s) 402.

Electronic storage 424 may comprise non-transitory storage media that electronically stores information. The electronic storage media of electronic storage 424 may include one or both of system storage that is provided integrally (i.e., substantially non-removable) with computing platform(s) 402 and/or removable storage that is removably connectable to computing platform(s) 402 via, for example, a port (e.g., a USB port, a firewire port, etc.) or a drive (e.g., a disk drive, etc.). Electronic storage 424 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 424 may include one or more virtual storage resources (e.g., cloud storage, a virtual private network, and/or other virtual storage resources). Electronic storage 424 may store software algorithms, information determined by processor(s) 426, information received from computing platform(s) 402, information received from remote platform(s) 404, and/or other information that enables computing platform(s) 402 to function as described herein.

Processor(s) 426 may be configured to provide information processing capabilities in computing platform(s) 402. As such, processor(s) 426 may include one or more of a digital processor, an analog processor, a digital circuit designed to process information, an analog circuit designed to process information, a state machine, and/or other mechanisms for electronically processing information. Although processor(s) 426 is shown in FIG. 4 as a single entity, this is for illustrative purposes only. In some embodiments, processor(s) 426 may include a plurality of processing units. These processing units may be physically located within the same device, or processor(s) 426 may represent processing functionality of a plurality of devices operating in coordination. Processor(s) 426 may be configured to execute modules 408, 410, 412, 414, 416, 418, and/or 420, and/or other modules. Processor(s) 426 may be configured to execute modules 408, 410, 412, 414, 416, 418, and/or 420, and/or other modules by software; hardware; firmware; some combination of software, hardware, and/or firmware; and/or other mechanisms for configuring processing capabilities on processor(s) 426. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 408, 410, 412, 414, 416, 418, and/or 420 are illustrated in FIG. 4 as being implemented within a single processing unit, in embodiments in which processor(s) 426 includes multiple processing units, one or more of modules 408, 410, 412, 414, 416, 418, and/or 420 may be implemented remotely from the other modules. The description of the functionality provided by the different modules 408, 410, 412, 414, 416, 418, and/or 420 described below is for illustrative purposes, and is not intended to be limiting, as any of modules 408, 410, 412, 414, 416, 418, and/or 420 may provide more or less functionality than is described. For example, one or more of modules 408, 410, 412, 414, 416, 418, and/or 420 may be eliminated, and some or all of its functionality may be provided by other ones of modules 408, 410, 412, 414, 416, 418, and/or 420. As another example, processor(s) 426 may be configured to execute one or more additional modules that may perform some or all of the functionality attributed below to one of modules 408, 410, 412, 414, 416, 418, and/or 420.

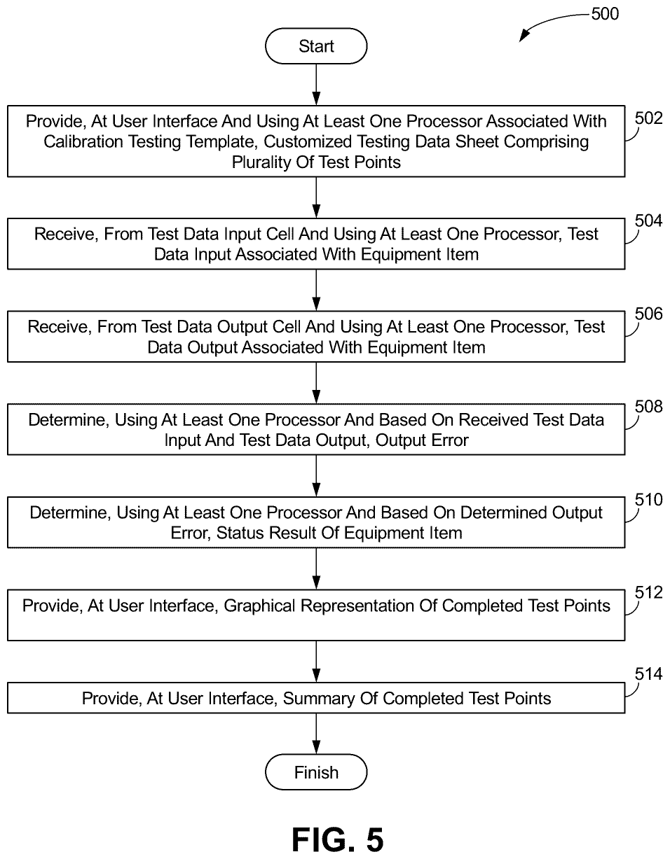

FIG. 5 illustrates an example process 500 associated with a calibration testing template, according to some embodiments of the present disclosure. The operations of process 500 presented below are intended to be illustrative. In some embodiments, process 500 may be accomplished with one or more additional operations not described, and/or without one or more of the operations discussed. Additionally, the order in which the operations of process 500 are illustrated in FIG. 5 and described below is not intended to be limiting.

In some embodiments, process 500 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of process 500 in response to instructions stored electronically on an electronic storage medium. The one or more processing devices may include one or more devices configured through hardware, firmware, and/or software to be specifically designed for execution of one or more of the operations of process 500.

At block 502, in some embodiments, process 500 may include at least one processor providing, at a user interface and using at least one processor associated with a calibration testing template, a customized testing data sheet including a plurality of test points. Each test point of the plurality of test points may include a target input indicator, a test data input cell, and a test data output cell. The at least one processor may be configured by testing data sheet providing module 408, in accordance with one or more embodiments.

At block 504, in some embodiments, process 500 may include at least one processor receiving, from the test data input cell and using the at least one processor, a test data input associated with an equipment item. The at least one processor may be configured by test data input receiving module 410, in accordance with one or more embodiments.

At block 506, in some embodiments, process 500 may include at least one processor receiving, from the test data output cell and using the at least one processor, a test data output associated with the equipment item. The at least one processor may be configured by test data output receiving module 412, in accordance with one or more embodiments.

At block 508, in some embodiments, process 500 may include at least one processor determining, using the at least one processor and based on the received test data input and test data output, an output error. The at least one processor may be configured by output error determination module 414, in accordance with one or more embodiments.

At block 510, in some embodiments, process 500 may include at least one processor determining, using the at least one processor and based on the determined output error, a status result of the equipment item. The at least one processor may be configured by status result determination module 416, in accordance with one or more embodiments.

At block 512, in some embodiments, process 500 may include at least one processor providing, at the user interface, a graphical representation of completed test points. The at least one processor may be configured by representation providing module 418, in accordance with one or more embodiments.

At block 514, in some embodiments, process 500 may include at least one processor providing, at the user interface, a summary of completed test points. The at least one processor may be configured by summary providing module 420, in accordance with one or more embodiments.

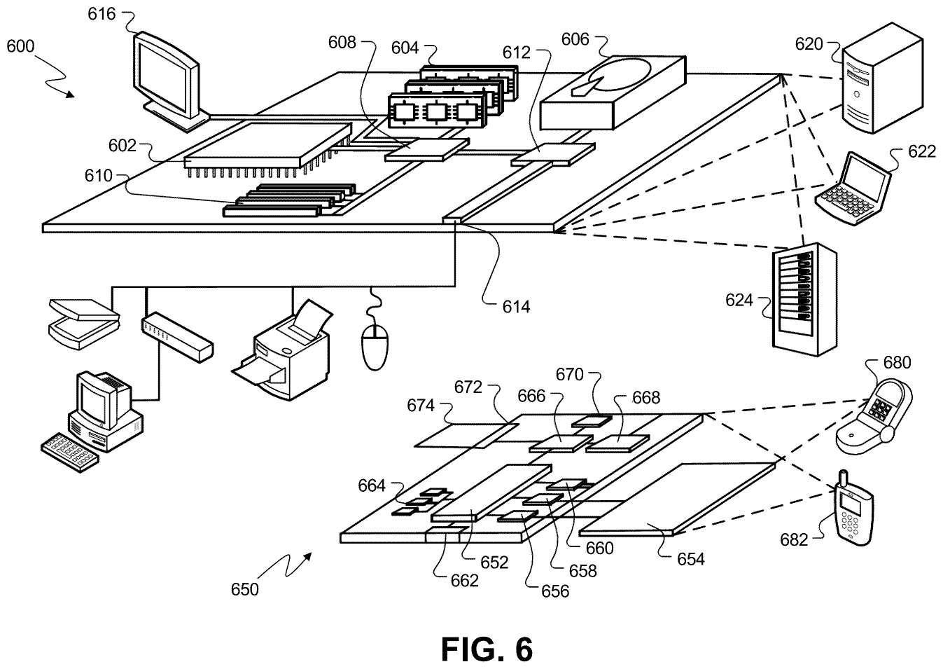

FIG. 6 is a block diagram of computing devices 600, 650 that may be used to implement the systems and methods described in this document, as either a client or as a server or plurality of servers. Computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smartphones, smartwatches, head-worn devices, and other similar computing devices. The components shown here, their connections and relationships, and their functions, are meant to be exemplary only, and are not meant to limit implementations described and/or claimed in this document.

Computing device 600 includes a processor 602, memory 604, a storage device 606, a high-speed interface 608 connecting to memory 604 and high-speed expansion ports 610, and a low-speed interface 612 connecting to low-speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high-speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a non-transitory computer-readable medium. In one implementation, the memory 604 is a volatile memory unit or units. In another implementation, the memory 604 is a non-volatile memory unit or units.

The storage device 606 is capable of providing mass storage for the computing device 600. In one implementation, the storage device 606 is a non-transitory computer-readable medium. In various different implementations, the storage device 606 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a non-transitory computer- or machine-readable medium, such as the memory 604, the storage device 606, or memory on processor 602.

The high-speed controller 608 manages bandwidth-intensive operations for the computing device 600, while the low speed controller 612 manages lower bandwidth-intensive operations. Such allocation of duties is exemplary only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device, such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can process instructions for execution within the computing device 650, including instructions stored in the memory 664. The processor may also include separate analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a thin-film-transistor liquid-crystal display (TFT LCD) display or an organic light-emitting diode (OLED) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provided in communication with processor 652, so as to enable near area communication of device 650 with other devices. External interface 662 may provide, for example, for wired communication (e.g., via a docking procedure) or for wireless communication (e.g., via Bluetooth or other such technologies).

The memory 664 stores information within the computing device 650. In one implementation, the memory 664 is a non-transitory computer-readable medium. In one implementation, the memory 664 is a volatile memory unit or units. In another implementation, the memory 664 is a non-volatile memory unit or units. Expansion memory 674 may also be provided and connected to device 650 through expansion interface 672, which may include, for example, a SIMM card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provided as a security module for device 650, and may be programmed with instructions that permit secure use of device 650. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, or memory on processor 652.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS receiver module 670 may provide additional wireless data to device 650, which may be used as appropriate by applications running on device 650.

Device 650 may also communicate audibly using audio codec 660, which may receive spoken information from a user and convert it to usable digital information. Audio codec 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smartphone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any non-transitory signal used to provide machine instructions and/or data to a programmable processor.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the invention have been described. Other embodiments are within the scope of the following claims. For example, the steps recited in the claims, described in the specification, or depicted in the figures can be performed in a different order and still achieve desirable results. In some cases, multitasking and parallel processing may be advantageous.

What is claimed is:

1. A method, comprising:
providing, at a user interface and using at least one processor associated with a calibration testing template, a customized testing data sheet comprising a plurality of test points, each test point of the plurality of test points including a target input indicator, a test data input cell, and a test data output cell;
receiving, from the test data input cell and using the at least one processor, a test data input associated with an equipment item;
receiving, from the test data output cell and using the at least one processor, a test data output associated with the equipment item;
determining, using the at least one processor and based on the received test data input and test data output, an output error; and
determining, using the at least one processor and based on the determined output error, a status result of the equipment item.

2. The method of claim 1, wherein at least one reference standard is assignable to the test data input and/or the test data output.

3. The method of claim 1, wherein a first reference standard is assigned to the test data input and a second reference standard is assigned to the test data output, the first reference standard being different than the second reference standard.

4. The method of claim 1, wherein the customized data sheet comprises a user text entry cell associated with each of the plurality of test points.

5. The method of claim 1, further comprising:
providing, at the user interface, a graphical representation of completed test points.

6. The method of claim 1, further comprising:
providing, at the user interface, a summary of completed test points.

7. The method of claim 1, wherein the test data input cells and the test data output cells of the plurality of test points are positioned along a single user interface.

8. A system, comprising:
one or more hardware processors configured by machine-readable instructions to:
provide, at a user interface and using at least one processor associated with a calibration testing template, a customized testing data sheet comprising a plurality of test points, each test point of the plurality of test points including a target input indicator, a test data input cell, and a test data output cell;
receive, from the test data input cell and using the at least one processor, a test data input associated with an equipment item;
receive, from the test data output cell and using the at least one processor, a test data output associated with the equipment item;
determine, using the at least one processor and based on the received test data input and test data output, an output error; and
determine, using the at least one processor and based on the determined output error, a status result of the equipment item.

9. The system of claim 8, wherein at least one reference standard is assignable to the test data input and/or the test data output.

10. The system of claim 8, wherein a first reference standard is assigned to the test data input and a second reference standard is assigned to the test data output, the first reference standard being different than the second reference standard.

11. The system of claim 8, wherein the customized data sheet comprises a user text entry cell associated with each of the plurality of test points.

12. The system of claim 8, wherein the one or more hardware processors are further configured by machine-readable instructions to:
provide, at the user interface, a graphical representation of completed test points.

13. The system of claim 8, wherein the one or more hardware processors are further configured by machine-readable instructions to:
provide, at the user interface, a summary of completed test points.

14. The system of claim 8, wherein the test data input cells and the test data output cells of the plurality of test points are positioned along a single user interface.

15. A computer-implemented calibration testing template configured to perform the following steps:
providing, at a user interface and using at least one processor associated with a calibration testing template, a customized testing data sheet comprising a plurality of test points, each test point of the plurality of test points including a target input indicator, a test data input cell, and a test data output cell;
receiving, from the test data input cell and using the at least one processor, a test data input associated with an equipment item;
receiving, from the test data output cell and using the at least one processor, a test data output associated with the equipment item;
determining, using the at least one processor and based on the received test data input and test data output, an output error; and
determining, using the at least one processor and based on the determined output error, a status result of the equipment item.

16. The computer-implemented calibration testing template of claim 15, wherein at least one reference standard is assignable to the test data input and/or the test data output.

17. The computer-implemented calibration testing template of claim 15, wherein a first reference standard is assigned to the test data input and a second reference standard is assigned to the test data output, the first reference standard being different than the second reference standard.

18. The computer-implemented calibration testing template of claim 15, wherein the customized data sheet comprises a user text entry cell associated with each of the plurality of test points.

19. The computer-implemented calibration testing template of claim 15, wherein the steps further comprise:
providing, at the user interface, a graphical representation of completed test points.

20. The computer-implemented calibration testing template of claim 15, wherein the steps further comprise:
providing, at the user interface, a summary of completed test points.

21. The computer-implemented calibration testing template of claim 15, wherein the test data input cells and the test data output cells of the plurality of test points are positioned along a single user interface.
